(19) United States
(12) Patent Application Publication
(10) Pub. No.: US 2008/0056524 A1
(43) Pub. Date: Mar. 6, 2008

(54) Microphone package

(75) Inventors: Shingo Sakakibara, Hamamatsu-shi (JP); Hiroshi Saitoh, Twata-shi (JP)

Correspondence Address: PILLSBURY WINTHROP SHAW PITTMAN LLP, P.O BOX 10500, McLean, VA, 22102, US

(73) Assignee: Yamaha Corporation, Hamamatsu (JP)

(21) Appl. No.: 11/899,321

(22) Filed: Sep. 5, 2007

(30) Foreign Application Priority Data
Sep. 6, 2006 (JP) 2006-241792

(51) Int. Cl. H04R 19/04

(52) U.S. Cl. 381/361

(57) ABSTRACT

A microphone package includes a housing, which has a cavity and a sound hole for allowing the cavity to communicate with the exterior, and a microphone chip, which is mounted on the mounting surface so as to detect sound within the cavity. The sound hole is opened in connection with the mounting surface and is surrounded by a projection wall projecting upwardly from the mounting surface at a prescribed position in proximity to the microphone chip.

### BACKGROUND OF THE INVENTION

1. Field of the Invention

The present invention relates to microphone packages encapsulating microphones such as silicon condenser microphones.

This application claims priority on Japanese Patent Application No. 2006-241792, the content of which is incorporated herein by reference.

2. Description of the Related Art

Japanese Patent Application Publication No. 2004-537182 teaches an example of a microphone package, in which a miniature silicon condenser microphone is encapsulated in a housing having a cavity and a sound hole communicating with the exterior, wherein a microphone chip (for detecting sound) and an LSI chip (for controlling the microphone chip) are mounted on the mounting surface of the housing by use of a die-bonding material. This type of microphone package can be redesigned such that the LSI chip is sealed with a resin (or a potting material), by which the LSI chip is protected In addition, it can be redesigned such that the sound hole is opened on the mounting surface of the housing for mounting the microphone chip and LSI chip.

However, the sound hole opened on the mounting surface of the housing for mounting the microphone chip may likely allow the “liquid” die-bonding material and the “liquid” potting material to flow into the inside during the manufacturing.

It is possible to prevent the die-bonding material and potting material from flowing into the sound hole by increasing the distance between the microphone chip and the sound hole. However, this increases the overall size of the microphone package; hence, it is very difficult to downsize the microphone package in the conventionally-known technology.

### SUMMARY OF THE INVENTION

It is an object of the present invention to provide a microphone package having a sound hole opened on the mounting surface for mounting a microphone chip, wherein the microphone package is designed to realize manufacturing and downsizing with ease.

A microphone package according to the present invention includes a housing having a cavity and a sound hole allowing the cavity to communicate with the exterior, and a microphone chip mounted on the mounting surface so as to detect sound within the cavity; and a projection wall that projects upwardly from the mounting surface at the prescribed position between the sound hole and the microphone chip.

In the manufacturing of the microphone package, a liquid die-bonding material is applied to the prescribed position for mounting the microphone chip on the mounting surface, wherein it is possible to prevent the liquid die-bonding material from flowing over the mounting surface by means of the projection wall. Therefore, even when the distance between the microphone chip and the sound hole is reduced, it is possible to prevent the liquid die-bonding material from flowing into the sound hole. In addition, the projection wall blocks the light incident into the sound hole; hence, it is possible to easily prevent the incident light from reaching the microphone chip composed of silicon.

In the above, the sound hole is surrounded by the projection wall, by which it is possible to reliably prevent the liquid die-bonding material from unexpectedly flowing into the sound hole.

In addition, the prescribed portion of an external connection wire is electrically connected to the microphone chip and is exposed on the upper surface of the projection wall. This makes it possible to prevent the liquid die-bonding material from covering the prescribed portion of the external connection wire when the microphone chip is fixed onto the mounting surface; thereafter, it is possible to easily establish an electrical connection between the microphone chip and the prescribed portion of the external connection wire. Furthermore, when an LSI chip for driving the controlling of the microphone chip is fixed onto the mounting surface, it is possible to reduce the difference between the height of an electrode pad formed on the upper surface of the microphone chip or the upper surface of the LSI chip and the height of the prescribed portion of the external connection wire. This makes it possible to easily perform wire bonding using a capillary between the electrode pad and the prescribed portion of the external connection wire.

Furthermore, the projection wall is further increased in height between the sound hole and the prescribed portion of the external connection wire. That is, when both of the LSI chip mounted on the mounting surface and the prescribed portion of the external connection wire electrically connected to the electrode pad are sealed with a resin (or a potting material), it is possible to prevent the potting material from flowing over the mounting surface by means of the projection wall; hence, it is possible to reliably prevent the potting material from flowing into the sound hole.

Moreover, the sound hole is surrounded by the projection wall further increased in height. This makes it possible to reliably prevent the potting material from flowing into the sound hole.

### BRIEF DESCRIPTION OF THE DRAWINGS

These and other objects, aspects, and embodiments of the present invention will be described in more detail with reference to the following drawings, in which:

FIG. 1 is an exploded perspective view showing that a substrate is combined with a cover board so as to form a microphone package in accordance with a preferred embodiment of the present invention;

FIG. 2 is a plan view showing the upper side of the microphone package;

FIG. 3 is a cross-sectional view taken along line A-A in FIG. 2;

FIG. 4 is a cross-sectional view taken along line B-B in FIG. 2;

FIG. 5 is a cross-sectional view taken along line C-C in FIG. 2;

FIG. 6 is a plan view showing the upper side of a microphone package according to a variation of the present embodiment;

FIG. 7 is a cross-sectional view taken along line D-D in FIG. 6;

FIG. 8 is a plan view showing the upper side of a microphone package according to another variation of the present embodiment; and

FIG. 9 is a cross-sectional view taken along line E-E in FIG. 8.

### DESCRIPTION OF THE PREFERRED EMBODIMENT

The present invention will be described in further detail by way of examples with reference to the accompanying drawings.

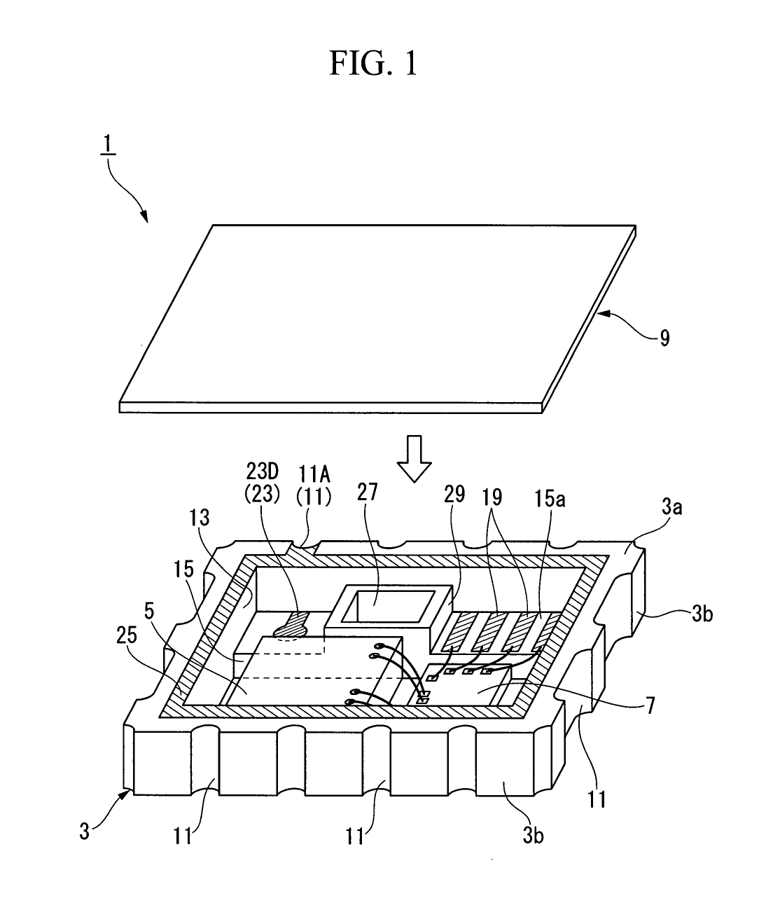

A microphone package 1 according to a preferred embodiment of the present invention will be described with reference to FIGS. 1 to 5. The microphone package 1 is constituted of a substrate 3, a microphone chip 5 arranged in connection with a surface 3a of the substrate 3, an LSI chip 7, and a cover board 9.

The substrate 3 is shaped like a plate having a rectangular shape in plan view, in which a plurality of recesses 11 are formed on a side wall 3b and are each opened in both of the surface 3a and a backside 3c. A hollow portion 13, which is recessed downwardly from the surface 3a, is formed in the substrate 3.

The microphone chip 5 and the LSI chip 7 are arranged on a bottom 13a (i.e., a mounting surface) of the hollow portion 13. As shown in FIGS. 1 to 4, a step portion 15 (or a wall) is formed and elongated along one side of the alignment of the microphone chip 5 and the LSI chip 7, wherein the step portion 15 projects upwardly from the bottom 13a of the hollow portion 13. The step portion 15 forms a step-like height difference between the bottom 13a of the hollow portion 13 and the surface 3a of the substrate 3.

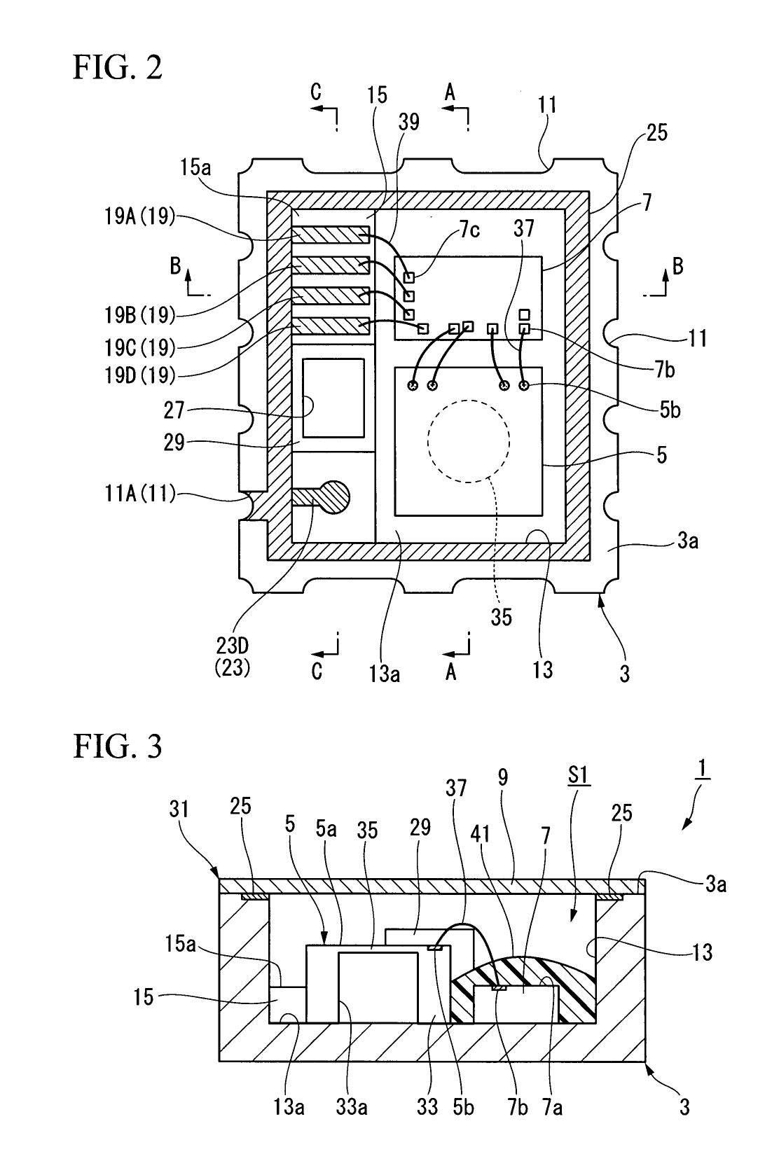

The substrate 3 is a multilayered wiring substrate composed of ceramics. As shown in FIGS. 2, 4 and 5, a plurality of external connection wires 17 are formed so as to electrically connect the microphone chip 5 and the LSI chip 7 to a circuit board (not shown) for mounting the microphone package 1.

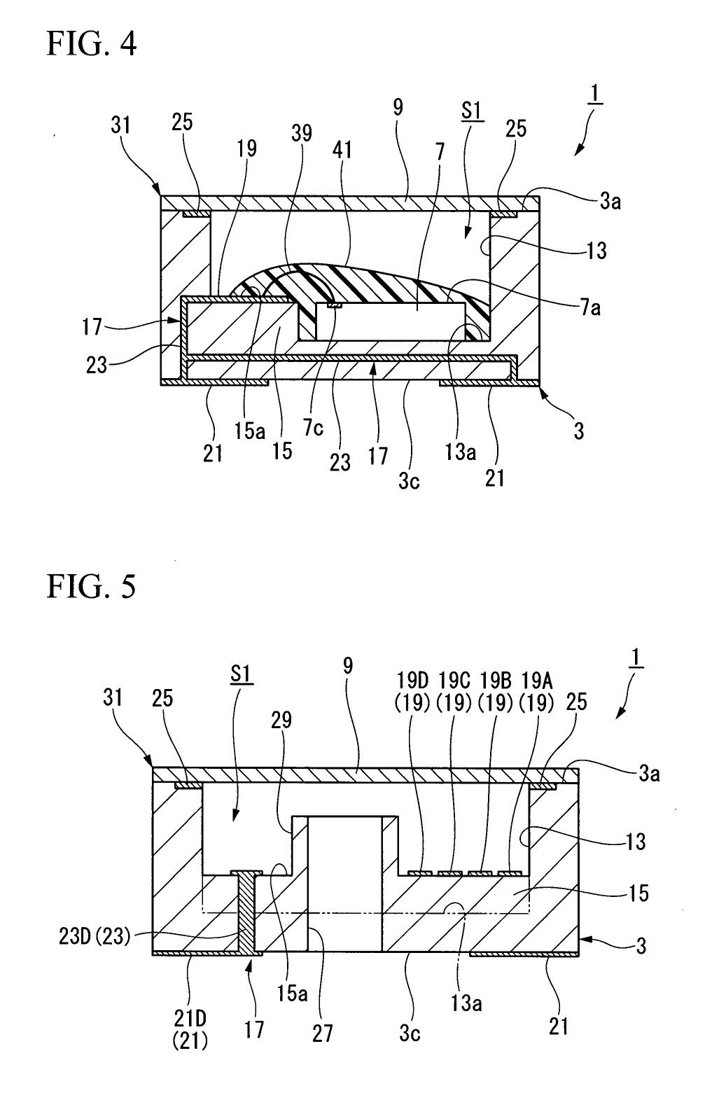

As shown in FIG. 4, each of the external connection wires 17 includes a first portion that is exposed on an upper surface 15a of the step portion 15 so as to form an internal terminal 19, which is electrically connected to the LSI chip 7, a second portion that is exposed on the backside 3c of the substrate 3 so as to form an external terminal 21, which is electrically connected to the circuit board, and a third portion that is elongated inside of the substrate 3 so as to form a conductive portion 23 for electrically connecting the internal terminal 19 and the external terminal 21.

As shown in FIG. 2, four internal terminals 19 (denoted by reference numerals 19A, 19B, 19C, and 19D) are aligned on the upper surface 15a of the step portion 15 in proximity to the LSI chip 7 along the alignment of the microphone chip 5 and the LSI chip 7. Specifically, the internal terminal 19A serves as a power terminal; the internal terminal 19B serves as an output signal terminal; the internal terminal 19C serves as a gain control terminal; and the internal terminal 19D serves as a ground terminal.

In the present embodiment, as shown in FIG. 2, the ground terminal 19D is electrically connected to a ground conduction portion 23D, which is formed on the upper surface 15a of the step portion 15 in proximity to the microphone chip 5. As shown in FIG. 5, the ground conduction portion 23D runs through the step portion 15 from the upper surface 15a to the backside 3a of the substrate 3 and is electrically connected to a ground external terminal 21D.

A ring-shaped connection pad 25 is formed on the surface 3a of the substrate 3. As shown in FIG. 2, a prescribed part of the ring-shaped connection pad 25 is horizontally elongated to reach a single recess 11A within the recesses 11 formed on the side walls 3b of the side wall 3b of the substrate 3. A conduction portion (not shown) is formed on the interior wall of the recess 11A. Thus, the ring-shaped connection pad 25 is electrically connected to the ground external terminal 21D, which is formed on the backside 3c of the substrate 3, via the conduction portion.

The external connection wires 17, the connection pad 25, and the conduction portion formed inside of the recess 11A are each formed by way of screen printing using a paste that is mainly composed of silver powder, copper powder, or tungsten powder, or using a paste in which binders (or acrylic resins) are mixed with the silver powder, copper powder, or tungsten powder. The internal terminals 19 exposed on the upper surface 15a of the step portion 15 are each formed by way of nickel and gold plating on the aforementioned materials. In addition, the external terminals 21 exposed on the backside 3c of the substrate 3 are each formed by way of nickel and gold plating on the aforementioned materials.

As shown in FIGS. 1, 2 and 5, a sound hole 27 runs through the substrate 3 from the backside 3c to the inside of the hollow portion 13. The sound hole 27 is opened on the upper surface 15a of the step portion 15 at a prescribed position between the internal terminals 19 and the ground conduction portion 23D. That is, the sound hole 27 is surrounded and defined by the step portion 15 that projects upwardly from the bottom 13a of the hollow portion 13.

A rectangular-shaped projection wall 29 projects upwardly from the upper surface 15a of the step portion 15 so as to vertically elongate and surround the sound hole 27. The distal end of the projection wall 29 is positioned at a height lower than the surface 3a of the substrate 3.

The cover board 9 is formed by performing nickel plating on a board composed of a conductive material such as copper. As shown FIGS. 3 to 5, the cover board 9 is fixed onto the surface 3a of the substrate 3 so as to cover the opening of the hollow portion 13, thus forming a cavity S1 embracing the microphone chip 5 and the LSI chip 7 together with the substrate 3. The cavity S1 communicates with the exterior via the sound hole 27 formed in the substrate 3.

The cover board 9 comes in contact with the connection pad 25 having conductivity and is thus electrically connected to the connection pad 25. That is, the cover board 9 is electrically connected to the ground external terminal 21D via the connection pad 25 and the conduction portion of the recess 11A.

The substrate 3 and the cover board 9 are combined together so as to form a housing 31 having the cavity S1 and the sound hole 27.

As shown in FIG. 3, the microphone chip 5 includes a diaphragm 35 (composed of silicon), which covers an inner hole 33a of a ring-shaped support 33. The diaphragm 35 detects sound by way of vibration thereof; hence, the microphone chip 5 forms a sound pressure sensor chip for converting the vibration of the diaphragm 35 into electric signals. The microphone chip 5 is fixed onto the bottom 13a of the hollow portion 13 of the substrate 3 via a die-bonding material (not shown) in such a way that the diaphragm 35 is positioned opposite to the bottom 13a via the inner hole 33a. An upper surface 5a of the microphone chip 5, which is fixed to the bottom 13a, is set to a prescribed height such that it is higher than the upper surface 15a of the step portion 15 but is lower than the distal end of the projection wall 29.

The LSI chip 7 drives and controls the microphone chip 5. The LSI chip 7 includes an amplification circuit for amplifying electric signals output from the microphone chip 5. Similar to the microphone chip 5, the LSI chip 7 is fixed onto the bottom 13a of the hollow portion 13 of the substrate 3 via a die-bonding material (not shown). As shown in FIGS. 3 and 4, an upper surface 7a of the LSI chip 7, which is fixed to the bottom 1 3a, is set to a prescribed height substantially identical to the height of the upper surface 15a of the step portion 15.

A single electrode pad 7b formed on the upper surface 7a of the LSI chip 7 is electrically connected to an electrode pad 5b formed on the upper surface 5a of the microphone chip 5 via a first wire 37. Other electrode pads 7c of the LSI chip 7 are each electrically connected to the internal terminals 19 via second wires 39. Thus, the microphone chip 5 is electrically connected to the external connection wires 17 via the LSI chip 7.

In the above, the LSI chip 7, the internal terminal 19, a part of the first wire 37, and the second wires 39 are sealed with a resin sealing portion 41 formed above the bottom 13a of the hollow portion 13 of the substrate 3. As the resin material (or potting material) forming the resin sealing portion 41, it is possible to use a silicon resin or an epoxy resin.

The height of the resin sealing portion 41 is set such that the top portion thereof is lower than the upper surface 5a of the microphone chip 5 and the distal end of the projection wall 29.

In the manufacturing of the microphone package 1, the substrate 3 is produced in advance. Each substrate 3 can be individually produced in advance. Instead, a plurality of substrates 3 are combined and collectively produced in advance, and then they are each divided into individual pieces, for example. When plural substrates 3 are combined and collectively produced in advance, a plurality of through-holes running through the thickness direction are formed between adjacently arranged substrates 3, and then the substrates 3 are each divided into individual pieces by way of breakage along the through-holes. This makes it possible to easily form the recesses 11 on the side wall 3b of the substrate 3, wherein the conduction portion for electrically connecting the connection pad 25 to the ground external terminal 21D can be easily formed on the interior wall of the recess 11A.

Due to the formation of the through-holes, it is possible to weaken the rigidity between the adjacently arranged substrates 3; hence, it is possible to easily divide the substrates 3 individually by way of simple bending along scribing regions between them.

Next, the liquid die-bonding material is applied to prescribed positions for mounting the microphone chip 5 and the LSI chip 7 on the bottom 13a of the hollow portion 13 of the substrate 3; then, it is hardened while the microphone chip 5 and the LSI chip 7 are arranged at the prescribed positions respectively; thus, the microphone chip 5 and the LSI chip 7 are firmly fixed onto the bottom 13a. In this process, even when the liquid die-bonding material flows over the bottom 13a, it is stopped at the step portion 15.

Thereafter, wire bonding is performed using a capillary (not shown), so that the first wire 37 is formed between the electrode pad 5b of the microphone chip 5 and the electrode pad 7b of the LSI chip 7, and the second wires 39 are formed between the other electrode pads 7c of the LSI chip 7 and the internal terminals 19. The wire bonding can be easily performed because both of the upper surface 7a of the LSI chip 7 and the upper surface 15a of the step portion 15 are substantially set to the same height.

After completion of the wire bonding, the liquid potting material is introduced into the hollow portion 13 of the substrate 3 from the upper side of the LSI chip 7; then, the liquid potting material is hardened so as to form the resin sealing portion 41 for sealing the LSI chip 7, the internal terminals 19, a part of the first wire 37, and the second wires 39. In this process, even when the liquid potting material flows over the bottom 13a and the upper surface 15a of the step portion 15, it is stopped at the projection wall 29.

In the present embodiment, both of the upper surface 5a of the microphone chip 5 and the distal end of the projection wall 29 are higher than the upper surface 7a of the LSI chip 7 and the upper surface 15a of the step portion 15. Therefore, by adjusting the amount of the potting material to be introduced into the hollow portion 13 of the substrate 3, it is possible to easily prevent the potting material from unexpectedly covering the upper surface 5a of the microphone chip 5 and to easily prevent the potting material from unexpectedly flowing into the sound hole 27.

Lastly, the cover board 9 is fixed onto the surface 3a of the substrate 3 by use of the conductive adhesive, thus completing the manufacturing of the microphone package 1.

As described above, during the manufacturing of the microphone package 1, it is possible to reliably stop the flow of the liquid die-bonding material applied to the bottom 13a by means of the step portion 15. Therefore, it is possible to reliably prevent the die-bonding material from flowing into the sound hole 27 even when the distance between the microphone chip 5, the LSI chip 7, and the sound hole 27 is reduced.

In addition, it is possible to prevent the internal terminals 19, which are formed on the upper surface 15a of the step portion 15, from being unexpectedly covered with the die-bonding material during the manufacturing. This makes it possible to easily establish electrical connection between the LSI chip 7 and the internal terminals 19.

Furthermore, it is possible to easily perform wire bonding because both of the upper surface 15a of the step portion 15 and the upper surface 7a of the LSI chip 7 are set to substantially the same height.

After completion of the wiring bonding, even when the liquid potting material is introduced into the hollow portion 13 of the substrate from the upper side of the LSI chip 7, the flow of the liquid potting material is stopped by the projection wall 29; hence, it is possible to reliably prevent the liquid potting material from unexpectedly flowing into the sound hole 27.

Due to the aforementioned technical features, it is possible to easily manufacture the microphone package 1.

In contrast to the conventionally-known technology, it is unnecessary in the present embodiment to increase the distance between the microphone chip 5 and the sound hole 27; hence, it is possible to easily downsize the microphone package 1.

In addition, light incident into the cavity S1 from the sound hole 27 is blocked by the step portion 15 and the projection wall 29. That is, it is possible to easily prevent the incident light from reaching the microphone chip 5 composed of silicon; hence, it is possible to easily prevent the microphone characteristics of the microphone chip 5 from being unexpectedly varied.

The cover board 9 is electrically connected to the ground external terminal 21D, which is then connected to a ground pattern of a circuit board (not shown). This makes it possible for the cover board 9 to block electromagnetic noise occurring outside of the microphone package 1. That is, it is possible to reliably prevent electromagnetic noise from unexpectedly reaching the microphone chip 5; hence, it is possible to avoid the erroneous operation of the microphone chip 5 due to electromagnetic noise.

The present embodiment is designed such that the upper surface 15a of the step portion 15, which projects upwardly from the bottom 13a, is set to substantially the same height as the upper surface 7a of the LSI chip 7; but this is not a restriction. That is, it is simply required to reduce the difference between the height of the upper surface 15a of the step portion 15 and the height of the upper surface 7a of the LSI chip 7. Due to the reduced difference between their heights, it is possible to easily perform wire bonding between the LSI chip 7 and the internal terminals 19.

The present embodiment is designed such that the ring-shaped projection wall 29 surrounding the sound hole 27 further projects upwardly from the upper surface 15a of the step portion 15; but this is not a restriction. It is simply required that the projection wall 29 be formed between the ground conduction portion 23D and the internal terminals 19, both of which are formed by means of the external connection wires 17. This constitution can reliably stop the flow of the liquid potting material by means of the projection wall 29; hence, it is possible to reliably prevent the liquid potting material from flowing into the sound hold 27.

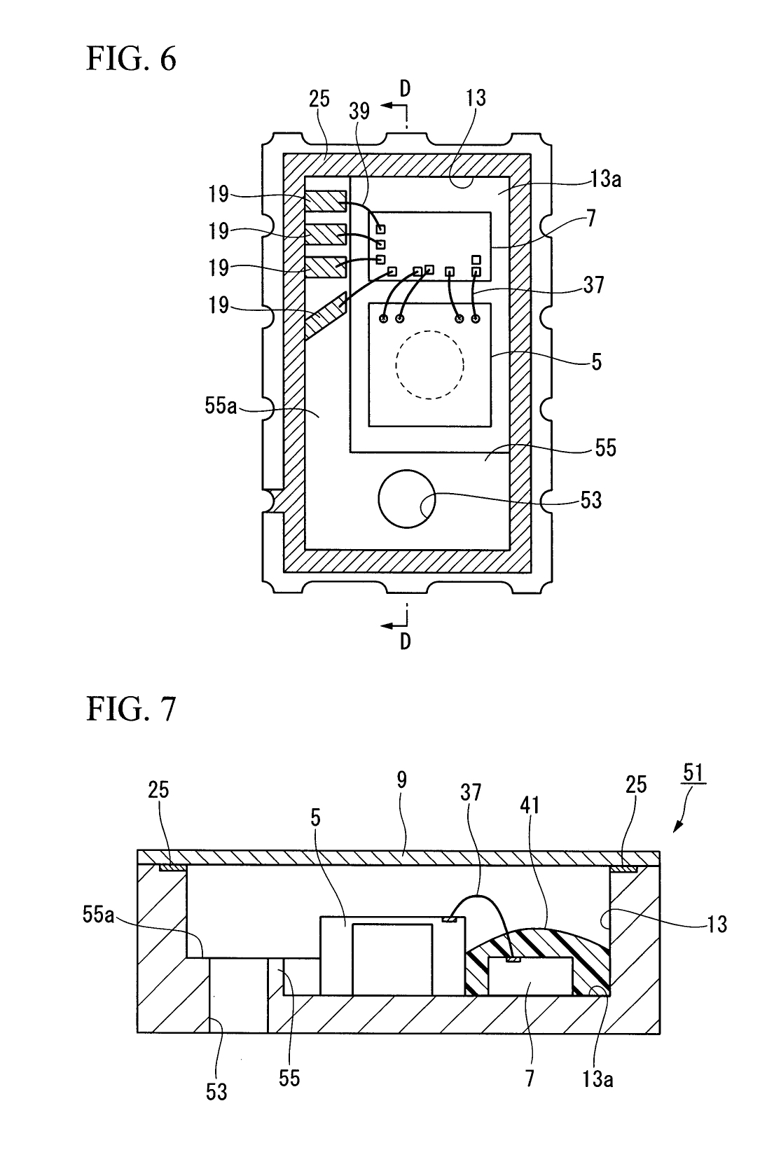

The present embodiment can be modified such that, without forming the projection wall 29 projecting upwardly from the step portion 15, the sound hole 27 is directly opened on the upper surface 15a of the step portion 15. That is, it is preferable that, in a microphone package 51 shown in FIGS. 6 and 7, a sound hole 53 be formed between the LSI chip 7 and the microphone chip 5. This constitution increases the region for forming the microphone chip 5 because the microphone chip 5 is sandwiched between the LSI chip 7 and a step portion (or a projection wall) 55 projecting upwardly from the bottom 13a of the hollow portion 13 of the substrate 3.

Since the sound hole 53 is formed along the alignment of the microphone chip 5 and the LSI chip 7, it is possible to increase the overall size of the microphone package 51 in the modification shown in FIGS. 6 and 7 compared with the present embodiment. Herein, the sound hole 53 is distanced from the LSI chip 7; hence, it is possible to adequately prevent the liquid potting material from unexpectedly flowing into the sound hole 53 without forming a projection wall projecting upwardly from an upper surface 55a of the step portion 55.

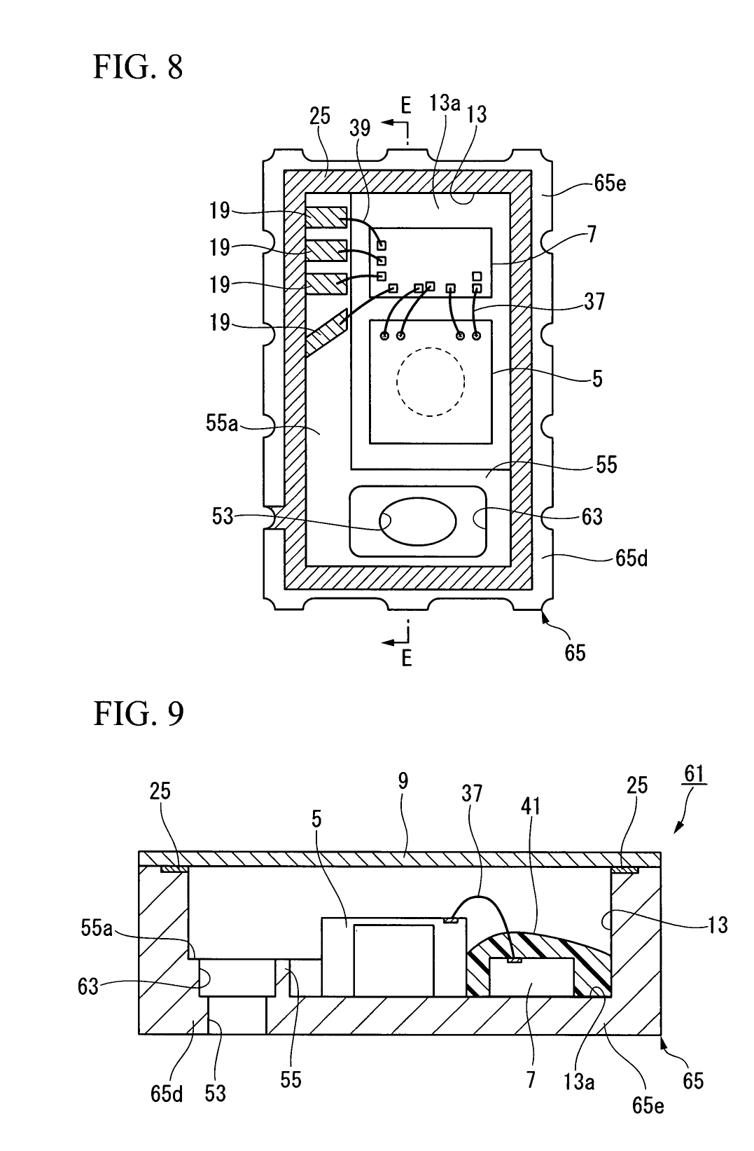

The microphone package 51, in which the step portion 55 is enlarged to sandwich the microphone chip 5 with the LSI chip 7, can be further modified as a microphone package 61 as shown in FIGS. 8 and 9, in which a bottomed recess 63, which is recessed from the upper surface 55a of the step portion 55, is formed in the periphery of the sound hole 53.

The microphone package 61 has a substrate 65, which is designed such that the thickness at a first end 65d forming the step portion 55 is larger than the thickness at a second end 65e arranging the LSI chip 7, wherein due to the formation of the bottomed recess 63, it is possible to realize substantially the same rigidity at both of the first end 65d and the second end 65e. For this reason, when a plurality of substrates 65 are combined and collectively produced and are then subjected to bending along scribing regions, it is possible to easily divide the individual substrates 65 by concentrating stress at the scribing regions.

The aforementioned microphone packages 1, 51, and 61 are designed such that the sound holes 27 and 53 are opened on the upper surfaces 15a and 55a of the step portions 15 and 55; but this is not a restriction. That is, the sound holes 27 and 53 can be directly opened on the bottoms 13a of the substrates 3 and 65, wherein ring-shaped walls, which are formed independently of the step portions 15 and 55, are formed to project upwardly from the bottoms 13a of the substrates 3 and 65 in the peripheries of the sound holes 27 and 53. The aforementioned walls are not necessarily formed in ring shapes, and it is simply required that they are each formed between the microphone chip 5, the LSI chip 7, and the sound holes 27 and 53. Herein, it is preferable that the height of the wall formed between the LSI chip 7 and each of the sound holes 27 and 53 be higher than the height of the LSI chip 7 so as to secure the formation of the resin sealing portion 41.

In the aforementioned constitutions, it is possible to reliably prevent the liquid die-bonding material from unexpectedly flowing into the sound holes 27 and 53 even when the distances between the microphone chip 5, the LSI chip 7, and the sound holes 27 and 53 are reduced; hence, it is possible to easily downsize the microphone packages 1, 51, and 61. In addition, it is possible to easily prevent light incident into the sound holes 27 and 53 from unexpectedly reaching the microphone chip 5; hence, it is possible to easily avoid unexpected variations of the microphone characteristics of the microphone chip 5 due to the incident light.

In the aforementioned constitution, it is possible to reliably prevent the liquid die-bonding material from unexpectedly flowing into the sound holes 27 and 53 even when the distances between the microphone chip 5, the LSI chip 7, and the sound holes 27 and 53 are reduced; hence, it is possible to easily downsize the microphone packages 1, 51, and 61. In addition, it is possible to easily prevent light incident into the sound holes 27 and 53 from unexpectedly reaching the microphone chip 5; hence, it is possible to easily avoid unexpected variations of the microphone characteristics of the microphone chip 5 due to the incident light.

All the microphone packages 1, 51, and 61 are each equipped with the LSI chip 7; but this is not a restriction. That is, it is simply required that each microphone package be equipped with the microphone chip 5, and that the electrode pads 5b of the microphone chip 5 be directly electrically connected to the internal terminals 19 via wires. In this constitution, the internal terminals 19 are still formed on the upper surfaces 15a and 55a of the step portion 15 and 55; this makes it possible to reduce the height differences between the internal terminals 19 and the electrode pads 5b of the microphone chip 5; hence, it is possible to easily perform wire bonding using a capillary.

All the microphone packages 1, 51, and 61 are each formed using the substrates 3 and 65 composed of ceramics; but this is not a restriction. That is, the substrates 3 and 65 can be each composed of glass or an epoxy resin, for example.

The housing 31 is constituted of the substrate 3 or 65 having the hollow portion 13 and the cover board 9 having the rectangular shape; but this is not a restriction. It is simply required that the housing 31 include the hollow cavity embracing the microphone chip 5 and the sound hole, which is opened in proximity to the mounting surface of the microphone chip 5 so as to establish communication between the hollow cavity and the exterior of the microphone package.

Lastly, the present invention is not necessarily limited to the present embodiment and variations, which can be further modified in a variety of ways within the scope of the invention defined by the appended claims.

What is claimed is:

1. A microphone package comprising:
a housing having a cavity and a sound hole for allowing the cavity to communicate with an exterior;
a microphone chip that is mounted on a mounting surface so as to detect sound within the cavity; and
a projection wall that projects upwardly from the mounting surface at a prescribed position between the sound hole and the microphone chip.

2. A microphone package according to claim 1, wherein the sound hole is surrounded by the projection wall.

3. A microphone package according to claim 2, wherein a prescribed portion of an external connection wire electrically connected to the microphone chip is exposed on an upper surface of the projection wall.

4. A microphone package according to claim 3, wherein the projection wall is further increased in height between the sound hole and the prescribed portion of the external connection wire.

5. A microphone package according to claim 4, wherein the sound hole is surrounded by the projection wall further increased in the height.
